(19) United States
(12) Patent Application Publication
(10) Pub. No.: US 2015/0208703 A1
(43) Pub. Date: Jul. 30, 2015

(54) Natural Sweetener

(71) Applicant: NatGood IP, LLC, Houston, TX (US)

(72) Inventor: Ryan Turner, Houston, TX (US)

(21) Appl. No.: 14/610,647

(22) Filed: Jan. 30, 2015

Related U.S. Application Data
(60) Provisional application No. 61/933,673, filed on Jan. 30, 2014.
(60) Provisional application No. 62/048,617, filed on Sep. 10, 2014.

(51) Int. Cl. A23L 1/236

(52) U.S. Cl. CPC A23L 1/2364; A23V 2002/00

(57) ABSTRACT

Disclosed herein is a natural sweetener composition comprising a sugar alcohol, a soluble fiber blend, a rheology modifier and an enhancing natural flavor. Also disclosed herein is a natural sweetener composition comprising a sugar alcohol, a soluble fiber blend, monk fruit extract, stevia extract, xanthan gum and an enhancing natural flavor. Also disclosed herein is a composition comprising from about 0.05 wt. % to about 0.75 wt. % stevia extract, from about 0.3 wt. %. to about 1.8 wt. % monk fruit extract, from about 40 wt. % to about 60 wt. % erythritol, from about 10 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

### CROSS-REFERENCE TO RELATED APPLICATIONS

This application claims priority to U.S. Provisional Patent Application Nos. 61/933,673 filed Jan. 30, 2014 and 62/048,617 filed Sep. 10, 2014 by Ryan Turner, and entitled “Natural Sweetener,” which is incorporated by reference.

### TECHNICAL FIELD

This disclosure relates to sweetener compositions. More specifically this disclosure relates to compositions for use as natural sweeteners.

### BACKGROUND

Today artificial sweeteners and other sugar substitutes are found in a variety of food and beverages marketed as “sugar-free” or “diet,” including soft drinks, chewing gum, jellies, baked goods, candy, fruit juice, ice cream, and yogurt. Artificial sweeteners are known by several names, which include: low-calorie sweeteners, high intensity sweeteners, non-sucrose sweeteners, intense sweeteners, non-nutritive sweeteners, sugar substitutes, and sugar-free sweeteners. Artificial sweeteners are loosely considered any sweetener used in place of regular table sugar (sucrose).

Artificial sweeteners are regulated by the Food and Drug Administration (FDA) as food additives. They must be reviewed and approved by the FDA before being made available for sale. In some cases, the FDA declares a substance “generally recognized as safe” (GRAS). These GRAS substances, including highly refined stevia preparations, are deemed by qualified professionals based on scientific data as being safe for their intended use, or they have such a lengthy history of common use in food that they're considered generally safe and don't require FDA approval before sale.

Natural sweeteners are touted as offering a healthful alternative to artificial sweeteners but current products have a variety of challenges associated with their use including caloric content, taste, and appearance. Thus an ongoing need exists for natural sweeteners having desirable characteristics.

### SUMMARY

Disclosed herein is a natural sweetener composition comprising a sugar alcohol, a soluble fiber blend, a rheology modifier and an enhancing natural flavor.

Also disclosed herein is a natural sweetener composition comprising a sugar alcohol, a soluble fiber blend, monk fruit extract, stevia extract, xanthan gum and an enhancing natural flavor.

Also disclosed herein is a composition comprising from about 0.05 wt. % to about 0.75 wt. % stevia extract, from about 0.3 wt. %. to about 1.8 wt. % monk fruit extract, from about 40 wt. % to about 60 wt. % erythritol, from about 10 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

Also disclosed herein is a composition comprising from about 0.05 wt. % to about 0.5 wt. % stevia extract, from about 0.3 wt. %. to about 2 wt. % monk fruit extract, from about 38 wt. % to about 60 wt. % erythritol, from about 5 wt. % to about 10 wt. % isomalto-oligosaccharides, from about 10 wt. % to about 40 wt. % chicory root extract, and from about 8 wt. % to about 45 wt. % maize dextrin wherein the wt. % is based on the total weight of the composition.

### DETAILED DESCRIPTION

Disclosed herein are natural sweetener compositions (NSC). Also disclosed herein are ingestible compositions (both edible and nonedible) comprising the NSC. In an embodiment, the NSC comprises at least one stevia extract, at least one monk fruit extract, one or more sugar alcohols, and one or more soluble fibers. An NSC of the type disclosed herein may optionally comprise natural flavors which only in combination, but not as single components, provide a property that enhances the flavor, mouth-feel and/or organoleptic properties of an NSC. In some embodiments, the NSC further comprises a rheology modifier. It is contemplated that an NSC further comprising a rheology modifier may be included in an ingestible composition prior to that composition being subjected to at least one thermal treatment (e.g., baking).

In an embodiment, the NSC comprises at least one extract of stevia. For purposes of the disclosure herein, a plant extract (e.g., stevia extract, monk fruit extract, etc.) can be defined as a preparation containing one or more active ingredients found in a plant or plant material, wherein the one or more active ingredients are in a concentrated form, when compared to the concentration of the one or more active ingredients in the plant or plant material. The plant extract generally comprises a carrier material, which can be an aqueous carrier (e.g., water), an alcohol based type carrier (e.g., ethanol, propanol, isopropanol, butanol, glycerol, etc.), or combinations thereof. Plant extracts can also be essential oils or resins.

Stevia extract is known to be a source of steviol glycosides which are responsible for the sweet taste of the leaves of the stevia plant (Stevia rebaudiana). Steviol glycosides range in sweetness from 40 to 300 times sweeter than sucrose and are also characterized as being heat-stable, pH-stable, and non-fermentable. In an embodiment, a Stevia extract suitable for use in the present disclosure is a GRAS formulation or material. For example the Stevia extract may comprise or consist essentially of purified Rabaudioside A. In an embodiment, the NSC comprises stevia extract in an amount of from about 0.01 weight percent (wt.) % to about 3 wt. %, alternatively from about 0.02 wt. % to about 1.8 wt. %, or alternatively from about 0.05 wt. % to about 0.8 wt. % based on the total weight of the NSC.

In an embodiment, the NSC comprises at least one monk fruit extract. Monk fruit is obtained from the plant Siraitia grosvenorii which is a herbaceous perennial vine of the Cucurbitaceae (gourd) family, native to southern China and northern Thailand. In an embodiment, a monk fruit extract suitable for use in the present disclosure is a GRAS formulation or material. For example, the monk fruit extract may be obtained from the Chinese monkfruit also known as Luo Han Guo. In an embodiment, the NSC comprises monk fruit extract in an amount of from about 0.05 wt. % to about 4 wt. %, alternatively from about 0.09 wt. % to about 3 wt. %, or alternatively from about 0.3 wt. % to about 2 wt. % based on the total weight of the NSC.

In an embodiment, the NSC comprises a sugar alcohol. Sugar alcohols, also known as polyols, polyhydric alcohols, or polyalcohols, are the hydrogenated forms of the aldoses or ketoses of a sugar. For example, glucitol, also known as sorbitol, has the same linear structure as the chain form of glucose, but the aldehyde (—CHO) group is replaced with a —CH₂OH group. Other common sugar alcohols include the monosaccharides erythritol and xylitol and the disaccharides lactitol and maltitol.

Generally, sugar alcohols can be characterized by the general formula HO—CH₂—(CH—OH)ₙ—CH₂—OH, wherein n is typically from 1 to 22. For example, when n=2, the sugar alcohol can be erythritol, threitol, etc. For example, when n=3, the sugar alcohol can be arabitol, xylitotl, ribitol, etc. For example, when n=4, the sugar alcohol can be mannitol, sorbitol, etc. The most common sugar alcohols have 5 or 6 carbon atoms in their structure, wherein n is 3 or 4, respectively. While sugar alcohols occur naturally, and can be isolated from plants, most often they are obtained by the selective hydrogenation of sugars. An alternative method of producing sugar alcohols is from fermentation of sugars. Sugars generally refer to aldoses or ketoses forms of a sugar.

In an embodiment, the sugar alcohol comprises mannitol, sorbitol, arabitol, threitol, xylitotl, ribitol, galactitol, fruitol, iditol, inositol, volemitol, isomalt, malitol, lactitol, or combinations thereof In an embodiment, the sugar alcohol comprises erythritol. In an embodiment, a sugar alcohol suitable for use in the present disclosure is a GRAS material or formulation.

In an embodiment, the sugar alcohol is present in the NSC in an amount of from about 20 wt. % to about 80 wt. %, alternatively from about 30 wt. % to about 70 wt. %, or alternatively from about 38 wt. % to about 60 wt. % based on the total weight of the NSC.

In an embodiment, the NSC comprises a soluble fiber blend (SFB). The term “soluble fiber blend” as used herein refers to the use of several soluble fibers in the NSC and is not meant to be limited to a particular form of the fiber or to a particular method of processing or introducing the fiber to the NSC. For example, the soluble fibers in the SFB may be premixed before being added to the remainder of the components of the NSC. Alternatively, the soluble fibers may be added singularly or in any combination other than a blending of all the fibers to the remaining components of the NSC where the remaining fiber is added to the NSC separately. Herein, the term “soluble fiber” refers to a mixture of short-chain carbohydrates that dissolve in water. In an embodiment, the SFB comprises oligosaccharides. In an embodiment, the soluble fiber suitable for use in the present disclosure is a GRAS material or formulation.

In an embodiment, the SFB comprises isomalto-oligosaccharides (IMOS). Herein, an IMOS refers to a mixture of short-chain carbohydrates comprising glucose oligomers with α-D-(1,6)-linkages. In an embodiment, the glucose oligomers comprise isomaltose, panose, isomaltotetraose, isomaltopentaose, nigerose, kojibiose, higher-branched oligosaccharides or combinations thereof.

In an embodiment, the SFB is present in the NSC in an amount of from about 10 wt. % to about 80 wt. %, alternatively from about 20 wt. % to about 60 wt. %, or alternatively from about 25 wt. % to about 45 wt. % based on the total weight of the NSC.

In an embodiment, the SFB comprises an inulin source such as chicory root extract. Chicory root extract is a dietary supplement or food additive produced by mixing dried, ground chicory root with water, and removing the insoluble fraction by filtration and centrifugation. Fresh chicory root typically contains, by dry weight, 68% inulin, 14% sucrose, 5% cellulose, 6% protein, 4% ash, and 3% other compounds. Dried chicory root extract contains, by weight, approximately 98% inulin and 2% other compounds. Fresh chicory root may contain between 13% and 23% inulin, by total weight.

In an embodiment the SFB comprises maize dextrin. Dextrins are mixtures of polymers of D-glucose units linked by α-(1→4) or α-(1→6) glycosidic bonds. Dextrins can be produced from starch using enzymes like amylases, as during malting and mashing, or by applying dry heat under acidic conditions (pyrolysis or roasting).

In an embodiment the SFB is present in the NSC in an amount of from about 10 wt. % to about 80 wt. %, alternatively from about 20 wt. % to about 60 wt. %, or alternatively from about 25 wt. % to about 45 wt. % based on the total weight of the NSC.

In an embodiment, the NSC optionally comprises an enhancing natural flavor which herein refers to a plurality of natural flavors that are combined to generate the enhancing natural flavor. Non-limiting examples of natural flavors suitable for use in the present disclosure include oils or extracts having flavors such as thaumatin; citrus fruits; berries; orange; lemon; lime; tangerine; mandarin; grapefruit; acerola; grape; pear; passion fruit; pineapple; banana; apple; cranberry; cherry; raspberry; chokeberry; grapeseed; peach; plum; grape; currant; black currant; cranberry; blackberry; blueberry; pomegranate; acai; noni; elderberry; goji berry; rosehips; bilberry; hawthorne berry; ginko; goru kola; rooibos; boysenberry; catuaba; horny goat weed; yohimbe; damiana; red raspberry leaf; vitex berry; blessed thistle; wolfberry; strawberry; mirabelle; watermelon; honeydew; cantaloupe; mango; papaya; botanical flavors derived from cola; tea; white tea; green tea; coffee; vanilla; almond; vegetables; tomato; cabbage; celery; cucumber; spinach; carrot; lettuce; watercress; dandelion; rhubarb; beet; cocona; cocoa; guava; Japanese knotweed; han guo, green tea, white tea, and any available tea blends; grapeseed; blueberries; or combinations thereof. In an embodiment, the enhancing natural flavor comprises lemon oil.

In an embodiment, the enhancing natural flavor is included in the NSC any amount suitable to meet some user and/or process need. For example, the amount of enhancing natural flavor included may be designed to provide a desired organoleptic effect. In an embodiment, the enhancing natural flavor is present in the NSC an amount of from about 0.001 wt. % to about 0.095 wt. %, alternatively from about 0.002 wt. % to about 0.050 wt. %, or alternatively from about 0.005 wt. % to about 0.010 wt. % based on the total weight of the NSC.

In an embodiment an NSC comprises from about 0.05 wt. % to about 0.75 wt. % stevia extract, from about 0.3 wt. %. to about 1.8 wt. % monk fruit extract, from about 40 wt. % to about 60 wt. % erythritol, from about 10 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.5 wt. % to about 0.8 wt. % stevia extract, from about 0.5 wt. %. to about 2 wt. % monk fruit extract, from about 38 wt. % to about 60 wt. % erythritol, from about 5 wt. % to about 25 wt. % isomalto-oligosaccharides, from about 10 wt. % to about 25 wt. % chicory root extract, and from about 8 wt. % to about 30 wt. % maize dextrin wherein the wt. % is based on the total weight of the composition.

In an embodiment an NSC comprises from about 0.05 wt. % to about 0.6 wt. % stevia extract, from about 0.3 wt. %. to about 2 wt. % monk fruit extract, from about 38 wt. % to about 55 wt. % erythritol, from about 20 wt. % to about 50 wt. % isomalto-oligosaccharides, from about 10 wt. % to about 25 wt. % chicory root extract, and from about 8 wt. % to about 20 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 5 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.7 wt. % stevia extract, from about 0.5 wt. %. to about 2 wt. % monk fruit extract, from about 38 wt. % to about 55 wt. % erythritol, from about 25 wt. % to about 50 wt. % isomalto-oligosaccharides, from about 10 wt. % to about 25 wt. % chicory root extract, and from about 8 wt. % to about 20 wt. % maize dextrin wherein the wt. % is based on the total weight of the composition.

In an embodiment an NSC comprises from about 0.1 wt. % to about 0.5 wt. % stevia extract, from about 0.5 wt. %. to about 1.2 wt. % monk fruit extract, from about 38 wt. % to about 60 wt. % erythritol, from about 15 wt. % to about 40 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 50 wt. % erythritol, from about 10 wt. % to about 50 wt. % isomalto-oligosaccharides, from about 10 wt. % to about 40 wt. % chicory root extract, and from about 8 wt. % to about 25 wt. % maize dextrin wherein the wt. % is based on the total weight of the composition.

In an embodiment an NSC comprises from about 0.05 wt. % to about 0.8 wt. % stevia extract, from about 0.3 wt. %. to about 1 wt. % monk fruit extract, from about 38 wt. % to about 60 wt. % erythritol, from about 5 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 5 wt. % to about 50 wt. % isomalto-oligosaccharides, from about 15 wt. % to about 25 wt. % chicory root extract, and from about 8 wt. % to about 45 wt. % maize dextrin wherein the wt. % is based on the total weight of the composition.

In an embodiment an NSC comprises from about 0.05 wt. % to about 0.5 wt. % stevia extract, from about 0.3 wt. %. to about 2 wt. % monk fruit extract, from about 38 wt. % to about 60 wt. % erythritol, from about 5 wt. % to about 10 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 1 wt. %. to about 2 wt. % monk fruit extract, from about 38 wt. % to about 50 wt. % erythritol, from about 5 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 15 wt. % to about 50 wt. % isomalto-oligosaccharides, from about 10 wt. % to about 40 wt. % chicory root extract, and from about 18 wt. % to about 45 wt. % maize dextrin wherein the wt. % is based on the total weight of the composition.

In an embodiment an NSC comprises from about 0.1 wt. % to about 0.8 wt. % stevia extract, from about 05 wt. %. to about 1 wt. % monk fruit extract, from about 38 wt. % to about 60 wt. % erythritol, from about 5 wt. % to about 50 wt. % isomalto-oligosaccharides, from about 10 wt. % to about 40 wt. % chicory root extract, and from about 10 wt. % to about 30 wt. % maize dextrin wherein the wt. % is based on the total weight of the composition.

In an embodiment an NSC comprises from about 0.2 wt. % to about 0.8 wt. % stevia extract, from about 0.3 wt. %. to about 2 wt. % monk fruit extract, from about 38 wt. % to about 60 wt. % erythritol, from about 5 wt. % to about 50 wt. % isomalto-oligosaccharides, from about 20 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 50 wt. % erythritol, from about 5 wt. % to about 45 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, from about 10 wt. % to about 40 wt. % chicory root extract, and from about 8 wt. % to about 28 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 5 wt. % to about 10 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.25 wt. % to about 0.8 wt. % stevia extract from about 38 wt. % to about 60 wt. % erythritol, from about 25 wt. % to about 50 wt. % isomalto-oligosaccharides, from about 10 wt. % to about 40 wt. % chicory root extract, and from about 0.001 wt. % to about 0.095 wt. % enhancing natural flavor wherein the wt. % is based on the total weight of the composition.

In an embodiment an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, from about 10 wt. % to about 40 wt. % chicory root extract, and from about 8 wt. % to about 28 wt. % maize dextrin and from about 0.001 wt. % to about 0.095 wt. % enhancing natural flavor wherein the wt. % is based on the total weight of the composition

In an embodiment an NSC comprises from about 0.15 wt. % to about 0.8 wt. % stevia extract, from about 0.3 wt. %. to about 2 wt. % monk fruit extract, from about 38 wt. % to about 60 wt. % erythritol, from about 5 wt. % to about 50 wt. % isomalto-oligosaccharides, from about 15 wt. % to about 27 wt. % chicory root extract, and from about 8 wt. % to about 45 wt. % maize dextrin wherein the wt. % is based on the total weight of the composition.

In an embodiment an NSC comprises from about 0.25 wt. % to about 0.8 wt. % stevia extract, from about 0.3 wt. %. to about 2 wt. % monk fruit extract, from about 38 wt. % to about 60 wt. % erythritol, from about 25 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 1.3 wt. %. to about 2 wt. % monk fruit extract, from about 38 wt. % to about 60 wt. % erythritol, from about 5 wt. % to about 15 wt. % isomalto-oligosaccharides, from about 10 wt. % to about 40 wt. % chicory root extract, and from about 8 wt. % to about 15 wt. % maize dextrin wherein the wt. % is based on the total weight of the composition.

In an embodiment an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 10 wt. % to about 40 wt. % chicory root extract, and from about 8 wt. % to about 28 wt. % maize dextrin and from about 0.001 wt. % to about 0.095 wt. % enhancing natural flavor wherein the wt. % is based on the total weight of the composition

In an embodiment an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, from about 10 wt. % to about 40 wt. % chicory root extract, and from about 8 wt. % to about 28 wt. % maize dextrin and from about 0.001 wt. % to about 0.075 wt. % enhancing natural flavor wherein the wt. % is based on the total weight of the composition

In an embodiment an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, from about 10 wt. % to about 40 wt. % chicory root extract, and from about 8 wt. % to about 28 wt. % maize dextrin and from about 0.025 wt. % to about 0.095 wt. % enhancing natural flavor wherein the wt. % is based on the total weight of the composition

In an embodiment an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, and from about 8 wt. % to about 28 wt. % maize dextrin and from about 0.001 wt. % to about 0.095 wt. % enhancing natural flavor wherein the wt. % is based on the total weight of the composition

In an embodiment an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides and from about 8 wt. % to about 28 wt. % maize dextrin and from about 0.015 wt. % to about 0.095 wt. % enhancing natural flavor wherein the wt. % is based on the total weight of the composition

In an embodiment an NSC comprises about 0.05 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, from about 10 wt. % to about 40 wt. % chicory root extract, and from about 8 wt. % to about 28 wt. % maize dextrin and about 0.055 wt. % enhancing natural flavor wherein the wt. % is based on the total weight of the composition

In an embodiment an NSC comprises from about 0.35 wt. % to about 0.8 wt. % stevia extract, from about 0.3 wt. %. to about 0.8 wt. % monk fruit extract, from about 38 wt. % to about 60 wt. % erythritol, from about 5 wt. % to about 32 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 50 wt. % erythritol, from about 5 wt. % to about 50 wt. % isomalto-oligosaccharides, from about 10 wt. % to about 40 wt. % chicory root extract, and from about 8 wt. % to about 35 wt. % maize dextrin wherein the wt. % is based on the total weight of the composition.

In an embodiment an NSC comprises from about 0.15 wt. % to about 0.55 wt. % stevia extract, from about 0.3 wt. %. to about 1.8 wt. % monk fruit extract, from about 38 wt. % to about 52 wt. % erythritol, from about 15 wt. % to about 46 wt. % isomalto-oligosaccharides, from about 10 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 17 wt. % to about 50 wt. % isomalto-oligosaccharides, from about 10 wt. % to about 40 wt. % chicory root extract, and from about 18 wt. % to about 45 wt. % maize dextrin wherein the wt. % is based on the total weight of the composition.

In an embodiment an NSC comprises from about 0.36 wt. % to about 0.8 wt. % stevia extract, from about 0.3 wt. %. to about 2 wt. % monk fruit extract, from about 38 wt. % to about 60 wt. % erythritol, from about 5 wt. % to about 50 wt. % isomalto-oligosaccharides, from about 10 wt. % to about 40 wt. % chicory root extract, and from about 8 wt. % to about 29 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 21 wt. % to about 27 wt. % isomalto-oligosaccharides, from about 10 wt. % to about 40 wt. % chicory root extract, and from about 22 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 5 wt. % to about 50 wt. % isomalto-oligosaccharides, from about 10 wt. % to about 36 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.5 wt. %. to about 2 wt. % monk fruit extract, from about 38 wt. % to about 60 wt. % erythritol, from about 5 wt. % to about 50 wt. % isomalto-oligosaccharides, from about 10 wt. % to about 40 wt. % chicory root extract, and from about 17 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 1.6 wt. % monk fruit extract, from about 38 wt. % to about 60 wt. % erythritol, from about 5 wt. % to about 50 wt. % isomalto-oligosaccharides, from about 12 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 5 wt. % to about 26 wt. % isomalto-oligosaccharides, from about 10 wt. % to about 40 wt. % chicory root extract, and from about 8 wt. % to about 26 wt. % maize dextrin wherein the wt. % is based on the total weight of the composition.

In an embodiment an NSC comprises from about 0.05 wt. % to about 0.41 wt. % stevia extract, from about 0.3 wt. %. to about 2 wt. % monk fruit extract, from about 38 wt. % to about 60 wt. % erythritol, from about 5 wt. % to about 50 wt. % isomalto-oligosaccharides, from about 19 wt. % to about 40 wt. % chicory root extract, and from about 8 wt. % to about 45 wt. % maize dextrin wherein the wt. % is based on the total weight of the composition.

In an embodiment an NSC comprises from about 0.05 wt. % to about 0.8 wt. % stevia extract, from about 0.3 wt. %. to about 2 wt. % monk fruit extract, from about 38 wt. % to about 60 wt. % erythritol, from about 24 wt. % to about 50 wt. % isomalto-oligosaccharides, from about 10 wt. % to about 40 wt. % chicory root extract, and from about 8 wt. % to about 34 wt. % maize dextrin wherein the wt. % is based on the total weight of the composition.

In an embodiment, the NSC is included in a composition that is to be subjected to a thermal treatment subsequent to introduction of the NSC to the composition. For example, the NSC may be introduced to a composition that is subsequently heated to temperatures equal to or greater than about 90° C., alternatively from about 90° C. to about 260° C., alternatively from about 100° C. to about 250° C., alternatively from about 110° C. to about 250° C., alternatively from about 125° C. to about 225° C., or alternatively from about 150° C. to about 200° C. In an embodiment, the composition that the NSC is introduced to is subsequently baked in a conventional oven. In such embodiments where the NSC is to be introduced to a composition that is subsequently thermally treated, the NSC may additionally comprise a rheology modifier. An NSC comprising a rheology modifier is referred to as a thermal blend NSC and designated T-NSC. It is to be understood that all properties disclosed herein for an NSC also applies to the T-NSC whether or not specifically recited.

A rheology modifier suitable for inclusion in the T-NSC may comprise any material compatible with the other components of the T-NSC and able to provide the compositional properties disclosed herein. In an embodiment, the rheology modifier comprises a polysaccharide, alternatively a polysaccharide gum. A polysaccharide gum suitable for use in the present disclosure may be further characterized as being hydrocolloidal.

A polysaccharide gum suitable for use in the T-NSC may be derived from natural sources or may be prepared synthetically. In an embodiment, the polysaccharide gum comprises alginate, carrageenan, xanthan, pectin, gellan, welan, pullulan, curdlan, rhamsan, sphingan polymers, or combinations thereof In an embodiment, the polysaccharide gum may be plant-derived. For example, carrageenan can extracted from certain species of the class Rhodophyceae (red seaweed) while xanthan gum, for example, is a polysaccharide that can be produced by fermentation using Xanthomonas bacterium. Gellan gum is the generic name of a polysaccharide that can be produced by cultured Pseudomonas elodea or related organisms. Curdlan is a polysaccharide gum that can be produced by a microorganism (e.g., Alcaligenes faecalis varmyxogenes). Still other polysaccharide gums can be produced either by extraction from plant material or by microbial fermentation. Alginate is a polysaccharide gum that can be obtained by extraction from certain species of seaweed, or alternatively Azotobacter vinelandii or Pseudomonas aeruginosa can be used to produce the polysaccharide gum through fermentation. In an embodiment, the polysaccharide gum comprises xanthan gum.

The backbone of the xanthan gum structure consists of two β-D-glucose units linked through the 1 and 4 positions. The side chain consists of two mannose and one glucuronic acid, so the chain consists of repeating modules of five sugar units. The side chain is linked to every other glucose of the backbone at the 3 position. About half of the terminal mannose units have a pyruvic acid group linked as a ketal to its 4 and 6 positions. The other mannose unit has an acetyl group at the 6 positions. In an embodiment, xanthan gum suitable for use in the present disclosure exhibits pseudoplasticity. The pseudoplasticity of xanthan gum is characteristic of a Non-Newtonian fluid and may be observable over a wide range of temperatures (e.g., 90° C. to 260° C.). Herein psuedoplasticity refers to the non-Newtonian behavior where a fluid's viscosity (i.e., the measure of a fluid's resistance to flow) decreases with an increasing rate of shear strain. In an embodiment, the rheology modifier may be present in the T-NSC in an amount ranging from about 0.01 wt. % to about 3 wt. %, alternatively from about 0.05 wt. % to about 2 wt. %, or alternatively from about 0.1 wt. % to about 1 wt. % based on the total weight of the T-NSC.

In an embodiment, a NSC and/or T-NSC of the type disclosed herein may be combined in any order and prepared using any suitable methodology. In an embodiment, an NSC and/or T-NSC of the type disclosed herein are formed into a particulate/ powder material using techniques such as fluid bed agglomeration. Herein, fluid bed agglomeration refers to a process involving suspension of particles in an air stream followed by the spraying of a liquid onto the fluidized bed (top-down spray). Particles in the path of the spray develop an adhesive quality (i.e., become sticky) and upon collision with other particles in the bed adhere and form granules. The process may be continued until the granules develop some user and/or process desired characteristics.

In an embodiment, the NSC and/or T-NSC may be prepared by the mixing of all components of the NSC and/or T-NSC with the exception of a liquid component (e.g., the enhancing natural flavor) in the fluidized bed. Agglomeration of the NSC and/or T-NSC may be accomplished by the spraying of the liquid (e.g., the enhancing natural flavor) onto the fluidized particles. In an embodiment, the NSC and/or T-NSC may be subjected to fluid bed agglomeration until a particular particle size distribution of the composition is reached. For example, fluid bed agglomeration of the NSC and/or T-NSC may be carried out to provide a mean particle size distribution ranging from about 250 microns to about 700 microns, alternatively from about 275 microns to about 500 microns, or alternatively from about 300 microns to about 400 microns. In an embodiment, the NSC and/or T-NSC may comprise less than about 25% of particles having a mean particle size of less than about 200 microns. Further the NSC and/or T-NSC may comprise less than about 25% of particles having a mean particle size of greater than about 800 microns. Fluid bed agglomeration of NSC and/or T-NSC compositions of the type disclosed herein may result in the formation of NSC and/or T-NSC powders having one or more user and/or process desired characteristics.

In an embodiment, the NSC and/or T-NSC powders have an apparent density comparable to that of table sugar. Herein, the apparent density refers to the mass of a unit volume of the NSC and/or T-NSC powder, which can be freely (without pressing or tapping) poured into a container. An NSC and/or T-NSC of the type disclosed herein may be characterized by an apparent density that is within about ±30% of the apparent density of table sugar, alternatively about ±20% of the apparent density of table sugar, or alternatively about ±10% of the apparent density of table sugar.

In an embodiment, the NSC and/or T-NSC powders have a compressibility that is increased when compared to that of table sugar. Herein, the compressibility refers to the degree to which the NSC and/or T-NSC powder compacts as a function of applied pressure. An NSC and/or T-NSC of the type disclosed herein may be characterized by a compressibility that is about 10% greater than the compressibility of table sugar, alternatively that is about 20% greater than the compressibility of table sugar, or alternatively that is about 30% greater than the compressibility of table sugar.

In an embodiment, the NSC and/or T-NSC powders have a flowability comparable to that of table sugar. Herein, the compressibility refers to ability of the NSC and/or T-NSC powder to flow through a calibrated orifice. An NSC and/or T-NSC powder of the type disclosed herein may be characterized by a flowability that is within about ±30% of the flowability of table sugar, alternatively about ±20% of the flowability of table sugar, or alternatively about ±10% of the flowability of table sugar.

In an embodiment, an NSC and/or T-NSC powder of the type disclosed herein has a sugar recipe equivalence (SRE) of about 100%. Herein, the SRE refers to the percentage of NSC and/or T-NSC equivalent to the amount of table sugar in a particular recipe. For example, a SRE of about 100% indicates that for a recipe using 1 cup of table sugar, 1 cup of an NSC and/or T-NSC of the type disclosed herein may be substituted. In an embodiment, an NSC and/or T-NSC of the type disclosed herein has an SRE of about 85%, alternatively about 90%, or alternatively 95%.

In an embodiment, an NSC and/or T-NSC powder of the type disclosed herein has a moisture retention value comparable to that of table sugar. Herein, the moisture retention value refers to the extent to which the NSC and/or T-NSC powder binds water in an ingestible product. An NSC and/or T-NSC powder of the type disclosed herein may be characterized by a moisture retention value that is within about ±30% of the moisture retention value of table sugar, alternatively about ±20% of the moisture retention value of table sugar, or alternatively about ±10% of the moisture retention value of table sugar.

In an embodiment, a T-NSC powder of the type disclosed herein has a rise ratio of about 1. Herein, the rise ratio refers to the extent to which a baked good rises when prepared with table sugar in comparison to the rise of the same baked good in the presence of a T-NSC of the type disclosed herein. In an embodiment, a T-NSC of the type disclosed herein has a rise ratio of about 0.85, alternatively about 0.90, or alternatively 0.95.

In an embodiment, an NSC comprises from about 0.5 wt. % to about 0.8 wt. % stevia extract, from about 0.5 wt. %. to about 2 wt. % monk fruit extract, from about 38 wt. % to about 60 wt. % erythritol, and from about 5 wt. % to about 25 wt. % isomalto-oligosaccharides, wherein the wt. % is based on the total weight of the composition.

In an embodiment, an NSC comprises from about 0.5 wt. % to about 2 wt. % stevia extract, from about 0.5 wt. %. to about 1 wt. % monk fruit extract, from about 25 wt. % to about 60 wt. % sugar alcohol, and from about 5 wt. % to about 45 wt. % soluble fiber blend wherein the wt. % is based on the total weight of the composition.

In an embodiment, an NSC comprises from about 0.5 wt. % to about 1.5 wt. % stevia extract, from about 0.5 wt. %. to about 0.8 wt. % monk fruit extract, from about 25 wt. % to about 40 wt. % sugar alcohol, and from about 5 wt. % to about 60 wt. % soluble fiber blend wherein the wt. % is based on the total weight of the composition.

In an embodiment, an NSC comprises from about 0.1 wt. % to about 1 wt. % stevia extract, from about 0.05 wt. %. to about 0.5 wt. % monk fruit extract, from about 25 wt. % to about 40 wt. % sugar alcohol, and from about 20 wt. % to about 50 wt. % soluble fiber blend wherein the wt. % is based on the total weight of the composition.

In an embodiment, an NSC comprises from about 0.5 wt. % to about 0.8 wt. % stevia extract, from about 0.5 wt. %. to about 2 wt. % monk fruit extract, from about 38 wt. % to about 60 wt. % erythritol, and from about 5 wt. % to about 25 wt. % isomalto-oligosaccharides wherein the wt. % is based on the total weight of the composition.

In an embodiment, a T-NSC comprises from about 0.5 wt. % to about 0.8 wt. % stevia extract, from about 0.5 wt. %. to about 2 wt. % monk fruit extract, from about 38 wt. % to about 60 wt. % erythritol, from about 0.1 wt. % to about 0.6 wt. % xanthan gum, and from about 5 wt. % to about 25 wt. % isomalto-oligosaccharides wherein the wt. % is based on the total weight of the composition.

In an embodiment, an NSC comprises from about 0.05 wt. % to about 0.6 wt. % stevia extract, from about 0.3 wt. %. to about 2 wt. % monk fruit extract, from about 38 wt. % to about 55 wt. % erythritol, and from about 20 wt. % to about 50 wt. % isomalto-oligosaccharides wherein the wt. % is based on the total weight of the composition.

In an embodiment, a T-NSC comprises from about 0.05 wt. % to about 0.6 wt. % stevia extract, from about 0.3 wt. %. to about 2 wt. % monk fruit extract, from about 38 wt. % to about 55 wt. % erythritol, from about 0.05 wt. % to about 2.0 wt. % xanthan gum, and from about 20 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 5 wt. % to about 50 wt. % isomalto-oligosaccharides, wherein the wt. % is based on the total weight of the composition.

In an embodiment, a T-NSC comprises from about 0.05 wt. % to about 0.8 wt. % stevia extract, from about 0.3 wt. %. to about 2 wt. % monk fruit extract, from about 38 wt. % to about 60 wt. % erythritol, from about 0.01 wt. % to about 1.0 wt. % xanthan gum, and from about 5 wt. % to about 50 wt. % isomalto-oligosaccharides wherein the wt. % is based on the total weight of the composition.

In an embodiment, an NSC comprises from about 0.05 wt. % to about 0.7 wt. % stevia extract, from about 0.5 wt. %. to about 2 wt. % monk fruit extract, from about 38 wt. % to about 55 wt. % erythritol, and from about 25 wt. % to about 50 wt. % isomalto-oligosaccharides wherein the wt. % is based on the total weight of the composition.

In an embodiment, a T-NSC comprises from about 0.05 wt. % to about 0.7 wt. % stevia extract, from about 0.5 wt. %. to about 2 wt. % monk fruit extract, from about 38 wt. % to about 55 wt. % erythritol, from about 0.05 wt. % to about 2.0 wt. % xanthan gum and from about 25 wt. % to about 50 wt. % isomalto-oligosaccharides wherein the wt. % is based on the total weight of the composition.

In an embodiment, an NSC comprises from about 0.1 wt. % to about 0.5 wt. % stevia extract, from about 0.5 wt. %. to about 1.2 wt. % monk fruit extract, from about 38 wt. % to about 60 wt. % erythritol, and from about 15 wt. % to about 40 wt. % isomalto-oligosaccharides wherein the wt. % is based on the total weight of the composition.

In an embodiment, a T-NSC comprises from about 0.1 wt. % to about 0.5 wt. % stevia extract, from about 0.5 wt. %. to about 1.2 wt. % monk fruit extract, from about 38 wt. % to about 60 wt. % erythritol, from about 0.05 wt. % to about 1.0 wt. % xanthan gum, and from about 15 wt. % to about 40 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 50 wt. % erythritol, and from about 10 wt. % to about 50 wt. % isomalto-oligosaccharides wherein the wt. % is based on the total weight of the composition.

In an embodiment, a T-NSC comprises from about 0.05 wt. % to about 0.8 wt. % stevia extract, from about 0.3 wt. %. to about 2 wt. % monk fruit extract, from about 38 wt. % to about 50 wt. % erythritol, from about 0.1 wt. % to about 1.5 wt. % xanthan gum, and from about 10 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 1 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, a T-NSC comprises from about 0.05 wt. % to about 0.8 wt. % stevia extract, from about 0.3 wt. %. to about 1 wt. % monk fruit extract, from about 38 wt. % to about 60 wt. % erythritol, from about 0.05 wt. % to about 0.5 wt. % xanthan gum, and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, a T-NSC comprises from about 0.05 wt. % to about 0.8 wt. % stevia extract, from about 0.3 wt. %. to about 2 wt. % monk fruit extract, from about 38 wt. % to about 60 wt. % erythritol, from about 0.1 wt. % to about 3.0 wt. % rheology modifier, and from about 5 wt. % to about 50 wt. % isomalto-oligosaccharides wherein the wt. % is based on the total weight of the composition.

In an embodiment, an NSC comprises from about 0.05 wt. % to about 0.5 wt. % stevia extract, from about 0.3 wt. %. to about 2 wt. % monk fruit extract, from about 38 wt. % to about 60 wt. % erythritol, and from about 5 wt. % to about 10 wt. % isomalto-oligosaccharides wherein the wt. % is based on the total weight of the composition.

In an embodiment, a T-NSC comprises from about 0.05 wt. % to about 0.5 wt. % stevia extract, from about 0.3 wt. %. to about 2 wt. % monk fruit extract, from about 38 wt. % to about 60 wt. % erythritol, from about 0.05 wt. % to about 2.0 wt. % rheology modifier, and from about 5 wt. % to about 10 wt. % isomalto-oligosaccharides wherein the wt. % is based on the total weight of the composition.

In an embodiment, an NSC comprises from about 0.05 wt. % to about 0.8 wt. % stevia extract, from about 1 wt. %. to about 2 wt. % monk fruit extract, from about 38 wt. % to about 50 wt. % erythritol, and from about 5 wt. % to about 50 wt. % isomalto-oligosaccharides wherein the wt. % is based on the total weight of the composition.

In an embodiment, a T-NSC comprises from about 0.05 wt. % to about 0.8 wt. % stevia extract, from about 1 wt. %. to about 2 wt. % monk fruit extract, from about 38 wt. % to about 50 wt. % erythritol, from about 0.01 wt. % to about 1.0 wt. % rheology modifier, and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 15 wt. % to about 50 wt. % isomalto-oligosaccharides wherein the wt. % is based on the total weight of the composition.

In an embodiment, a TONSC comprises from about 0.05 wt. % to about 0.8 wt. % stevia extract, from about 0.3 wt. %. to about 2 wt. % monk fruit extract, from about 38 wt. % to about 60 wt. % erythritol, from about 0.01 wt. % to about 0.5 wt. % rheology modifier, and from about 15 wt. % to about 50 wt. % isomalto-oligosaccharides wherein the wt. % is based on the total weight of the composition.

In an embodiment, an NSC comprises from about 0.1 wt. % to about 0.8 wt. % stevia extract, from about 05 wt. %. to about 1 wt. % monk fruit extract, from about 38 wt. % to about 60 wt. % erythritol and from about 5 wt. % to about 50 wt. % isomalto-oligosaccharides wherein the wt. % is based on the total weight of the composition.

In an embodiment, a T-NSC comprises from about 0.1 wt. % to about 0.8 wt. % stevia extract, from about 05 wt. %. to about 1 wt. % monk fruit extract, from about 38 wt. % to about 60 wt. % erythritol, from about 0.01 wt. % to about 1.0 wt. % rheology modifier, and from about 5 wt. % to about 50 wt. % isomalto-oligosaccharides wherein the wt. % is based on the total weight of the composition.

In an embodiment, an NSC comprises from about 0.2 wt. % to about 0.8 wt. % stevia extract, from about 0.3 wt. %. to about 2 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, a T-NSC comprises from about 0.2 wt. % to about 0.8 wt. % stevia extract, from about 0.3 wt. %. to about 2 wt. % monk fruit extract, from about 38 wt. % to about 60 wt. % erythritol, from about 0.1 wt. % to about 0.75 wt. % rheology modifier, and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 50 wt. % erythritol, and from about 5 wt. % to about 45 wt. % soluble fiber blend wherein the wt. % is based on the total weight of the composition.

In an embodiment, a T-NSC comprises from about 0.05 wt. % to about 0.8 wt. % stevia extract, from about 0.3 wt. %. to about 2 wt. % monk fruit extract, from about 38 wt. % to about 50 wt. % erythritol, from about 0.05 wt. % to about 2.0 wt. % rheology modifier and from about 5 wt. % to about 45 wt. % soluble finer wherein the wt. % is based on the total weight of the composition.

In an embodiment, an NSC comprises from about 0.05 wt. % to about 0.8 wt. % stevia extract, from about 1.5 wt. %. to about 2 wt. % monk fruit extract, from about 38 wt. % to about 47 wt. % erythritol, and from about 5 wt. % to about 50 wt. % isomalto-oligosaccharides wherein the wt. % is based on the total weight of the composition.

In an embodiment, a T-NSC comprises from about 0.05 wt. % to about 0.8 wt. % stevia extract, from about 0.3 wt. %. to about 2 wt. % monk fruit extract, from about 38 wt. % to about 60 wt. % erythritol, from about 0.05 wt. % to about 0.5 wt. % xanthan gum, and from about 5 wt. % to about 10 wt. % isomalto-oligosaccharides wherein the wt. % is based on the total weight of the composition.

In an embodiment, an NSC comprises from about 0.25 wt. % to about 0.8 wt. % stevia extract from about 38 wt. % to about 60 wt. % erythritol, and from about 25 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides and from about 0.001 wt. % to about 0.095 wt. % enhancing natural flavor wherein the wt. % is based on the total weight of the composition.

In an embodiment, an NSC comprises from about 0.15 wt. % to about 0.8 wt. % stevia extract, from about 0.3 wt. %. to about 2 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, a T-NSC comprises from about 0.25 wt. % to about 0.8 wt. % stevia extract, from about 0.3 wt. %. to about 2 wt. % monk fruit extract, from about 38 wt. % to about 60 wt. % erythritol, from about 25 wt. % to about 50 wt. % isomalto-oligosaccharides, and from about 0.2 wt. % to about 5.0 wt. % rheology modifier wherein the wt. % is based on the total weight of the composition.

In an embodiment, an NSC comprises from about 0.05 wt. % to about 0.8 wt. % stevia extract, from about 1.3 wt. %. to about 2 wt. % monk fruit extract, from about 38 wt. % to about 60 wt. % erythritol, and from about 5 wt. % to about 15 wt. % isomalto-oligosaccharides wherein the wt. % is based on the total weight of the composition.

In an embodiment, an NSC comprises from about 0.05 wt. % to about 0.8 wt. % stevia extract, from about 1.5 wt. %. to about 2 wt. % monk fruit extract, from about 38 wt. % to about 47 wt. % erythritol, and from about 0.001 wt. % to about 0.095 wt. % enhancing natural flavor wherein the wt. % is based on the total weight of the composition.

In an embodiment, a T-NSC comprises from about 0.05 wt. % to about 0.8 wt. % stevia extract, from about 1.5 wt. %. to about 2 wt. % monk fruit extract, from about 38 wt. % to about 47 wt. % erythritol, from about 0.05 wt. % to about 2.0 wt. % rheology modifier, and from about 0.001 wt. % to about 0.095 wt. % enhancing natural flavor wherein the wt. % is based on the total weight of the composition.

In an embodiment, an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, and from about 0.001 wt. % to about 0.075 wt. % enhancing natural flavor wherein the wt. % is based on the total weight of the composition.

In an embodiment, an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, and from about 0.025 wt. % to about 0.095 wt. % enhancing natural flavor wherein the wt. % is based on the total weight of the composition.

In an embodiment, an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, and from about 0.001 wt. % to about 0.095 wt. % enhancing natural flavor wherein the wt. % is based on the total weight of the composition.

In an embodiment, an NSC comprises from about 0.05 wt. % to about 0.8 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides and from about 0.015 wt. % to about 0.095 wt. % enhancing natural flavor wherein the wt. % is based on the total weight of the composition.

In an embodiment, an NSC comprises about 0.05 wt. % stevia extract, from about 1.5 wt. %. to about 2 wt. % monk fruit extract, from about 38 wt. % to about 47 wt. % erythritol, from about 5 wt. % to about 50 wt. % isomalto-oligosaccharides, and about 0.055 wt. % enhancing natural flavor wherein the wt. % is based on the total weight of the composition.

In an embodiment, an NSC comprises from about 0.35 wt. % to about 0.8 wt. % stevia extract, from about 0.3 wt. %. to about 0.8 wt. % monk fruit extract, from about 38 wt. % to about 60 wt. % erythritol, and from about 5 wt. % to about 32 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 50 wt. % erythritol, and from about 5 wt. % to about 50 wt. % isomalto-oligosaccharides wherein the wt. % is based on the total weight of the composition.

In an embodiment, an NSC comprises from about 0.15 wt. % to about 0.55 wt. % stevia extract, from about 0.3 wt. %. to about 1.8 wt. % monk fruit extract, from about 38 wt. % to about 52 wt. % erythritol, and from about 15 wt. % to about 46 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 17 wt. % to about 50 wt. % isomalto-oligosaccharides wherein the wt. % is based on the total weight of the composition.

In an embodiment, an NSC comprises from about 0.36 wt. % to about 0.8 wt. % stevia extract, from about 0.3 wt. %. to about 2 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, an NSC comprises from about 0.36 wt. % to about 0.8 wt. % stevia extract, from about 0.3 wt. %. to about 2 wt. % monk fruit extract, from about 38 wt. % to about 60 wt. % erythritol, from about 0.1 wt. % to about 1.0 wt. % xanthan gum and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 21 wt. % to about 27 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.5 wt. %. to about 2 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 1.6 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 5 wt. % to about 26 wt. % isomalto-oligosaccharides wherein the wt. % is based on the total weight of the composition.

In an embodiment, an NSC comprises from about 0.05 wt. % to about 0.41 wt. % stevia extract, from about 0.3 wt. %. to about 2 wt. % monk fruit extract, from about 38 wt. % to about 60 wt. % erythritol, and from about 5 wt. % to about 50 wt. % isomalto-oligosaccharides wherein the wt. % is based on the total weight of the composition.

In an embodiment, an NSC comprises from about 0.05 wt. % to about 0.8 wt. % stevia extract, from about 0.3 wt. %. to about 2 wt. % monk fruit extract, from about 38 wt. % to about 60 wt. % erythritol, and from about 24 wt. % to about 50 wt. % isomalto-oligosaccharides wherein the wt. % is based on the total weight of the composition.

In an embodiment, a T-NSC comprises from about 0.05 wt. % to about 0.8 wt. % stevia extract, from about 0.3 wt. %. to about 2 wt. % monk fruit extract, from about 38 wt. % to about 60 wt. % erythritol, from about 0.05 wt. % to about 2.0 wt. % rheology modifier and from about 24 wt. % to about 50 wt. % isomalto-oligosaccharides wherein the wt. % is based on the total weight of the composition.

In an embodiment, an NSC and/or T-NSC of the type disclosed herein is included in an edible composition such as a food product. Herein “edible” refers to a material that is fit to be eaten as food. In an embodiment, an NSC and/or T-NSC of the type disclosed herein can be included in an edible composition by using any suitable methodology. The NSC and/or T-NSC of the type disclosed herein can be mixed, dry mixed, wet mixed, blended, pureed, crushed, mashed, simmered, vortexed, stirred, agitated, shaken, sprinkled, sprayed, pulverized, and the like, or combinations thereof. “Food” herein refers to any edible product intended for consumption by humans or animals, including solids, semi-solids, or liquids (e.g., beverages). The term “food” and the term “food and beverage” are herein used interchangeably. Examples of food and beverage products or formulations include, but are not limited to sweet coatings, frostings, or glazes for comestible products or any entity included in the Soup category, the Dehydrated and Culinary Food Category, the Dried Processed Food category, the Beverage category, the Ready Meal category, the Canned or Preserved Food category, the Frozen Processed Food category, the Chilled Processed Food category, the Snack Food category, the Baked Goods category, the Confectionary category, the Dairy Product category, the Ice Cream category, the Meal Replacement category, the Pasta and Noodle category, the Sauces, Dressings, Condiments category, the Baby Food category, and/or the Spreads category.

In general, the Soup category refers to canned/preserved, dehydrated, instant, chilled, ultra-high temperature (UHT) and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

“Dehydrated and Culinary Food Category” herein refers to: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

The Beverage category herein refers to beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes alcoholic drinks, soft drinks, sports drinks, isotonic beverages, and hot drinks. The alcoholic drinks include, but are not limited to beer, cider/perry, flavored alcoholic beverages, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The hot drinks include, but are not limited to coffee, such as fresh, instant, and combined coffee; tea, such as black, green, white, oolong, and flavored tea; and other hot drinks including flavor-, malt- or plant-based powders, granules, blocks or tablets mixed with milk or water.

The Snack Food category generally refers to any food that can be a light informal meal including, but not limited to sweet and savory snacks and snack bars. Examples of snack food include, but are not limited to fruit snacks, chips/crisps, extruded snacks, tortilla/corn chips, popcorn, pretzels, nuts and other sweet and savory snacks. Examples of snack bars include, but are not limited to granola/muesli bars, breakfast bars, energy bars, fruit bars and other snack bars.

The Baked Goods category generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

The Ice Cream category generally refers to frozen dessert containing cream, sugar and flavoring. Examples of ice cream include, but are not limited to: impulse ice cream; take-home ice cream; frozen yogurt and artisanal ice cream; soy, oat, bean (e.g., red bean and mung bean), and rice-based ice creams.

The Confectionary category generally refers to edible products that are sweet to the taste. Examples of confectionary include, but are not limited to candies, gelatins, chocolate confectionery, sugar confectionery, gum, and the likes and any combination products.

The Meal Replacement category generally refers to any food intended to replace the normal meals, particularly for people having health and/or fitness concerns. Examples of meal replacements include, but are not limited to slimming products and convalescence products.

The Ready Meal category generally refers to any food that can be served as a meal without extensive preparation or processing. The ready meal category includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads.

The Pasta and Noodle category includes any pastas and/or noodles including, but not limited to canned, dried and chilled/fresh pasta; and plain, instant, chilled, frozen and snack noodles.

The Canned/Preserved Food category includes, but is not limited to canned/preserved meat and meat products, fish/seafood, vegetables, tomatoes, beans, fruit, ready meals, soup, pasta, and other canned/preserved foods.

The Frozen Processed Food category includes, but is not limited to frozen processed red meat, processed poultry, processed fish/seafood, processed vegetables, meat substitutes, processed potatoes, bakery products, desserts, ready meals, pizza, soup, noodles, and other frozen food.

The Dried Processed Food category includes, but is not limited to rice, dessert mixes, dried ready meals, dehydrated soup, instant soup, dried pasta, plain noodles, and instant noodles.

The Chill Processed Food category includes, but is not limited to chilled processed meats, processed fish/seafood products, lunch kits, fresh cut fruits, ready meals, pizza, prepared salads, soup, fresh pasta and noodles.

The Sauces, Dressings and Condiments category includes, but is not limited to tomato pastes and purees, bouillon/stock cubes, herbs and spices, monosodium glutamate (MSG), table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

The Baby Food category includes, but is not limited to milk- or soybean-based formula; and prepared, dried and other baby food.

The Spreads category includes, but is not limited to jams and preserves, honey, chocolate spreads, nut based spreads, and yeast based spreads.

The Dairy Product category generally refers to edible products produced from mammal's milk. Examples of dairy product include, but are not limited to drinking milk products, cheese, yogurt and sour milk drinks, and other dairy products.

Exemplary foods include confectioneries, chocolate confectionery, tablets, countlines, bagged selflines/softlines, boxed assortments, standard boxed assortments, twist wrapped miniatures, seasonal chocolate, chocolate with toys, alfaj ores, other chocolate confectionery, mints, standard mints, powder mints, boiled sweets, pastilles, gums, jellies and chews, toffees, caramels and nougat, medicated confectionery, lollipops, liquorice, other sugar confectionery, gum, chewing gum, sugarized gum, sugar-free gum, functional gum, bubble gum, cough drops, herbs, seeds, spices, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, ready to eat cereals, family breakfast cereals, flakes, muesli, other cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yogurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, fruit juices, vegetable juices, cream, cheese, processed cheese, spreadable processed cheese, unspreadable processed cheese, unprocessed cheese, spreadable unprocessed cheese, hard cheese, packaged hard cheese, unpackaged hard cheese, yogurt, plain/natural yogurt, flavored yogurt, fruited yogurt, probiotic yogurt, drinking yogurt, regular drinking yogurt, probiotic drinking yogurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded cereals and snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, hot soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, yeast-based spreads, toppings, and syrups.

In one embodiment, foods include alcoholic beverages, baby food, baby formula, baked goods, breakfast cereals, cheese, chewing gum, coffee whiteners, condiments and relishes, confectionary and frostings, crackers, dairy products, egg products, fats and oils, fish products, frozen dairy, frozen dinners, fruit ices, gelatins and puddings, grain mixtures, granulated sugar, gravies, hard candy, imitation dairy products, coffee, coffee products and coffee beverages, jams and jellies, meat products, milk products, non-alcoholic beverages, nut products, grains and grain products, poultry, processed fruits, processed vegetables, reconstituted vegetables, ready to eat meals, salad dressings, seasonings and flavors, snack foods, soft candy, soups, sugar substitutes, sweet sauce, sweetener blends, table top sweeteners, tea, tea products, and tea beverages.

In an embodiment, foods include table top sweeteners and beverages. Beverages include, but are not limited to, fruit juices, soft drinks, tea, coffee, beverage mixes, milk drinks, alcoholic and nonalcoholic beverages.

In an embodiment, an NSC and/or T-NSC is included in a non-edible ingestible product. Herein “ingestible” has its ordinary and customary meaning as referring to a characteristic of being able to be taken into the body. Herein, “non-edible products” refer to supplements, nutraceuticals, functional food products (e.g., any fresh or processed food claimed to have a health-promoting and/or disease-preventing properties beyond the basic nutritional function of supplying nutrients), pharmaceutical and over the counter products, oral care products such as dentifrices and mouthwashes, cosmetic products such as sweetened lip balms and other personal care products that use sucralose and/or other sweeteners. In general, over the counter (OTC) product and oral care product generally refer to product for household and/or personal use which may be sold without a prescription and/or without a visit to a medical professional. Examples of the OTC products include, but are not limited to vitamins and dietary supplements; topical analgesics and/or anesthetic; cough, cold and allergy remedies; antihistamines and/or allergy remedies; and combinations thereof Vitamins and dietary supplements include, but are not limited to vitamins, dietary supplements, tonics/bottled nutritive drinks, child-specific vitamins, dietary supplements, any other products of or relating to or providing nutrition, and combinations thereof Topical analgesics and/or anesthetic include any topical creams/ointments/gels used to alleviate superficial or deep-seated aches and pains, e.g. muscle pain; teething gel; patches with analgesic ingredient; and combinations thereof. Cough, cold and allergy remedies include, but are not limited to decongestants, cough remedies, pharyngeal preparations, medicated confectionery, antihistamines and child-specific cough, cold and allergy remedies; and combination products. Antihistamines and/or allergy remedies include, but are not limited to any systemic treatments for hay fever, nasal allergies, insect bites and stings. Examples of oral care product include, but are not limited to mouth cleaning strips, toothpaste, toothbrushes, mouthwashes/dental rinses, denture care, mouth fresheners, at-home teeth whiteners and dental floss.

In an embodiment, a food product of the type disclosed herein comprises an NSC and/or T-NSC also of the type disclosed herein. In such embodiments, the food product may be utilized after introduction of the NSC and/or T-NSC to the food product with no additional heat-treatment of the food product. In another embodiment, a food product of the type disclosed herein comprises an NSC and/or T-NSC, also of the type disclosed herein. In such embodiments, the food product may be heat-treated (e.g., baked) subsequent to the addition of the NSC and/or T-NSC. An NSC and/or T-NSC may be provided as a syrup which is a thick, viscous liquid consisting primarily of a solution of the NSC and/or T-NSC in water, containing a large amount of dissolved sugars but showing little tendency to deposit crystals. For example the NSC and/or T-NSC may be provided as syrup containing from about 10 wt. % to a saturated solution of the NSC and/or T-NSC in an aqueous solution.

In an embodiment, an NSC and/or T-NSC of the type disclosed herein is characterized by a great taste, a reduced cooling effect, a low glycemic index, and exertion of positive effects on the digestive health of the subject ingesting the NSC and/or T-NSC or an ingestible product comprising the NSC and/or T-NSC.

In an embodiment, the NSC and/or T-NSC exhibit a reduced cooling effect when dissolved in a solvent such as water. Herein, the cooling effect refers to the endothermic solvation of the composition, more specifically to the negative heat of solution of the sugar alcohols disclosed herein. For example, the heat of solution of crystalline erythritol is −42.9 cal/g. The cooling effect of sugar alcohols may be manifested in a subject's sensory perception of a cooling sensation when ingesting the sugar alcohols. In an embodiment, a NSC and/or T-NSC may have a cooling effect that is reduced from about 5% to about 25%, alternatively by from about 10% to about 25% or alternatively by from about 10% to about 20% when compared to an otherwise similar composition in the absence of the soluble fiber blend. In an embodiment, a NSC and/or T-NSC may have a cooling effect that is reduced from about 5% to about 25%, alternatively by from about 10% to about 25% or alternatively by from about 10% to about 20% when compared to an otherwise similar composition in the absence of the stevia extract.

In an embodiment, the NSC and/or T-NSC are characterized by a low glycemic index. The glycemic index (GI) is a measure of how quickly blood glucose levels (i.e., blood sugar) rise after eating a particular type of food. The effects that different foods have on blood glucose levels vary considerably. The GI estimates how much each gram of available carbohydrate (total carbohydrate minus fiber) in a food raises a person's blood glucose level following consumption of the food, relative to consumption of pure glucose. Glucose has a GI of 100. In an embodiment, the NSC and/or T-NSC has a GI of from about 5 to about 50, alternatively from about 10 to about 40, or alternatively from about 8 to about 25.

In an embodiment, the NSC and/or T-NSC is a component of an ingestible product (e.g., edible) and exerts a positive effect on the digestive health of the subject consuming the ingestible product. In an embodiment, the NSC and/or T-NSC is a prebiotic. Herein, prebiotic refers to non-digestible food ingredients that stimulate the growth and/or activity of bacteria in the digestive system in ways claimed to be beneficial to health. These characteristics may be useful in the management of one or more disorders or dysfunction, for example the NSC and/or T-NSC and compositions comprising the NSC and/or T-NSC may facilitate the control of diabetes and/or lower LDL blood cholesterol by interfering with the absorption of dietary cholesterol for the subject ingesting the NSC.

In an embodiment, the NSC may also affect blood glucose levels and have a beneficial effect on insulin sensitivity. Insulin is a hormone that is normally released by the beta cells of the pancreas. When a person's pancreas cannot produce enough insulin to sustain good health, that person may have to undergo treatment (e.g., injections) to maintain adequate metabolic functions. For example, insulin resistance is associated with numerous health risks. For one thing, it causes hyperinsulinemia, or high circulating insulin levels, which may be directly damaging to blood vessels. Hyperinsulinemia is also associated with high blood pressure, heart disease and heart failure, obesity (particularly abdominal obesity), osteoporosis (thinning bones), and certain types of cancer, such as colon, breast, and prostate cancer. In contrast, having low circulating insulin levels is associated with greater longevity.

The following are enumerated embodiments are provided as non-limiting examples:

A first embodiment which is a natural sweetener composition comprising a sugar alcohol, a soluble fiber blend, a rheology modifier, and an enhancing natural flavor.

A second embodiment which is the natural sweetener composition of the first embodiment formulated to have a mean particle size distribution ranging from about 250 microns to about 700 microns.

A third embodiment which is the natural sweetener composition of any of the first through second embodiments comprising less than about 25% of particles having a mean particle size distribution of less than about 200 microns.

A fourth embodiment which is the natural sweetener composition of any of the first through third embodiments comprising less than about 25% of particles having a mean particle size of greater than about 800 microns.

A fifth embodiment which is the natural sweetener composition of any of the first through fourth embodiments having an apparent density that is within about ±30% of the apparent density of table sugar.

A sixth embodiment which is the natural sweetener composition of any of the first through fifth embodiments having a compressibility that about 10% greater than the compressibility of table sugar.

A seventh embodiment which is the natural sweetener composition of any of the first through sixth embodiments having a flowability that is within about ±30% of the flowability of table sugar.

An eighth embodiment which is the natural sweetener composition of any of the first through seventh embodiments having a sugar recipe equivalence of about 100%.

A ninth embodiment which is the natural sweetener composition of any of the first through eighth embodiments having a moisture retention value that is within about ±30% of the moisture retention value of table sugar.

A tenth embodiment which is the natural sweetener composition of any of the first through ninth embodiments having a rise ratio of about 1.

An eleventh embodiment which is the natural sweetener composition of any of the first through tenth embodiments comprising a sugar alcohol, a soluble fiber blend, monk fruit extract, stevia extract, xanthan gum and an enhancing natural flavor.

A twelfth embodiment which is the natural sweetener composition of any of the first through eleventh embodiments wherein the soluble fiber blend comprises isomalto-oligosaccharides, the sugar alcohol comprises erythritol and the composition has from about 0.5 wt. % to about 0.8 wt. % stevia extract, from about 0.5 wt. %. to about 2 wt. % monk fruit extract, from about 38 wt. % to about 60 wt. % erythritol, and from about 5 wt. % to about 25 wt. % isomalto-oligosaccharides, wherein the wt. % is based on the total weight of the composition.

A thirteenth embodiment which is the natural sweetener composition of any of the first through twelfth embodiments having from about 0.5 wt. % to about 2 wt. % stevia extract, from about 0.5 wt. %. to about 1 wt. % monk fruit extract, from about 25 wt. % to about 60 wt. % sugar alcohol, and from about 5 wt. % to about 45 wt. % soluble fiber blend wherein the wt. % is based on the total weight of the composition.

A fourteenth embodiment which is the natural sweetener composition of any of the first through thirteenth embodiments wherein the sugar alcohol comprises erythritol and the soluble fiber blend comprises isomalto-oligosaccharides and the composition has from about 0.05 wt. % to about 0.6 wt. % stevia extract, from about 0.3 wt. %. to about 2 wt. % monk fruit extract, from about 38 wt. % to about 55 wt. % erythritol, from about 0.05 wt. % to about 2.0 wt. % xanthan gum, and from about 20 wt. % to about 50 wt. % isomalto-oligosaccharides wherein the wt. % is based on the total weight of the composition.

A fifteenth embodiment which is the natural sweetener composition of any of the first through fourteenth embodiments wherein the sugar alcohol comprises erythritol and the soluble fiber blend comprises isomalto-oligosaccharides and the composition has from about 0.05 wt. % to about 0.7 wt. % stevia extract, from about 0.5 wt. %. to about 2 wt. % monk fruit extract, from about 38 wt. % to about 55 wt. % erythritol, and from about 25 wt. % to about 50 wt. % isomalto-oligosaccharides wherein the wt. % is based on the total weight of the composition.

A sixteenth embodiment which is the natural sweetener composition of any of the first through fifteenth embodiments wherein the sugar alcohol comprises erythritol and the soluble fiber blend comprises isomalto-oligosaccharides and the composition has from about 0.1 wt. % to about 0.5 wt. % stevia extract, from about 0.5 wt. %. to about 1.2 wt. % monk fruit extract, from about 38 wt. % to about 60 wt. % erythritol, from about 0.05 wt. % to about 1.0 wt. % xanthan gum, and from about 15 wt. % to about 40 wt. % isomalto-oligosaccharides wherein the wt. % is based on the total weight of the composition.

A seventeenth embodiment which is the natural sweetener composition of any of the first through sixteenth embodiments wherein the sugar alcohol comprises erythritol and the soluble fiber blend comprises isomalto-oligosaccharides and the composition has from about 0.05 wt. % to about 0.8 wt. % stevia extract, from about 0.3 wt. %. to about 2 wt. % monk fruit extract, from about 38 wt. % to about 50 wt. % erythritol, and from about 10 wt. % to about 50 wt. % isomalto-oligosaccharides wherein the wt. % is based on the total weight of the composition.

An eighteenth embodiment which is an ingestible product comprising the sweetener composition of any of the first through seventeenth embodiments.

A nineteenth embodiment which is a composition comprising from about 0.05 wt. % to about 0.75 wt. % stevia extract, from about 0.3 wt. %. to about 1.8 wt. % monk fruit extract, from about 40 wt. % to about 60 wt. % erythritol, from about 10 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

A twentieth embodiment which is a composition comprising from about 0.05 wt. % to about 0.5 wt. % stevia extract, from about 0.3 wt. %. to about 2 wt. % monk fruit extract, from about 38 wt. % to about 60 wt. % erythritol, from about 5 wt. % to about 10 wt. % isomalto-oligosaccharides, from about 10 wt. % to about 40 wt. % chicory root extract, and from about 8 wt. % to about 45 wt. % maize dextrin wherein the wt. % is based on the total weight of the composition.

While embodiments of the present disclosure have been shown and described, modifications thereof can be made by one skilled in the art without departing from the spirit and teachings of the disclosure. The embodiments described herein are exemplary only, and are not intended to be limiting. Many variations and modifications of the disclosure are possible and are within the scope of the invention. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference in the Background is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed above and throughout the text are provided solely for their disclosure prior to the filing date of the present application. Nothing herein is to be construed as an admission that the inventors are not entitled to antedate such disclosure by virtue of prior invention.

Unless indicated otherwise, when a range of any type is disclosed or claimed it is intended to disclose or claim individually each possible number that such a range could reasonably encompass, including any sub-ranges encompassed therein. When describing a range of measurements every possible number that such a range could reasonably encompass can, for example, refer to values within the range with one significant digit more than is present in the end points of a range. Moreover, when a range of values is disclosed or claimed, which Applicants intent to reflect individually each possible number that such a range could reasonably encompass, Applicants also intend for the disclosure of a range to reflect, and be interchangeable with, disclosing any and all sub-ranges and combinations of sub-ranges encompassed therein. Accordingly, Applicants reserve the right to proviso out or exclude any individual members of any such group, including any sub-ranges or combinations of sub-ranges within the group, if for any reason Applicants choose to claim less than the full measure of the disclosure.

What is claimed is:

1. A natural sweetener composition comprising a sugar alcohol, a soluble fiber blend, a rheology modifier, and an enhancing natural flavor.

2. The natural sweetener composition of claim 1 formulated to have a mean particle size distribution ranging from about 250 microns to about 700 microns.

3. The natural sweetener composition of claim 1 comprising less than about 25% of particles having a mean particle size distribution of less than about 200 microns.

4. The natural sweetener composition of claim 1 comprising less than about 25% of particles having a mean particle size of greater than about 800 microns.

5. The natural sweetener composition of claim 1 having an apparent density that is within about ±30% of the apparent density of table sugar.

6. The natural sweetener composition of claim 1 having a compressibility that about 10% greater than the compressibility of table sugar.

7. The natural sweetener composition of claim 1 having a flowability that is within about ±30% of the flowability of table sugar.

8. The natural sweetener composition of claim 1 having a sugar recipe equivalence of about 100%.

9. The natural sweetener composition of claim 1 having a moisture retention value that is within about ±30% of the moisture retention value of table sugar.

10. The natural sweetener composition of claim 1 having a rise ratio of about 1.

11. A natural sweetener composition comprising a sugar alcohol, a soluble fiber blend, monk fruit extract, stevia extract, xanthan gum, and an enhancing natural flavor.

12. The natural sweetener composition of claim 11 wherein the soluble fiber blend comprises isomalto-oligosaccharides, the sugar alcohol comprises erythritol and the composition has from about 0.5 wt. % to about 0.8 wt. % stevia extract, from about 0.5 wt. %. to about 2 wt. % monk fruit extract, from about 38 wt. % to about 60 wt. % erythritol, and from about 5 wt. % to about 25 wt. % isomalto-oligosaccharides, wherein the wt. % is based on the total weight of the composition.

13. The natural sweetener composition of claim 11 having from about 0.5 wt. % to about 2 wt. % stevia extract, from about 0.5 wt. %. to about 1 wt. % monk fruit extract, from about 25 wt. % to about 60 wt. % sugar alcohol, and from about 5 wt. % to about 45 wt. % soluble fiber blend wherein the wt. % is based on the total weight of the composition.

14. The natural sweetener composition of claim 11 wherein the sugar alcohol comprises erythritol and the soluble fiber blend comprises isomalto-oligosaccharides and the composition has from about 0.05 wt. % to about 0.6 wt. % stevia extract, from about 0.3 wt. %. to about 2 wt. % monk fruit extract, from about 38 wt. % to about 55 wt. % erythritol, from about 0.05 wt. % to about 2.0 wt. % xanthan gum, and from about 20 wt. % to about 50 wt. % isomalto-oligosaccharides wherein the wt. % is based on the total weight of the composition.

15. The natural sweetener composition of claim 11 wherein the sugar alcohol comprises erythritol and the soluble fiber blend comprises isomalto-oligosaccharides and the composition has from about 0.05 wt. % to about 0.7 wt. % stevia extract, from about 0.5 wt. %. to about 2 wt. % monk fruit extract, from about 38 wt. % to about 55 wt. % erythritol, and from about 25 wt. % to about 50 wt. % isomalto-oligosaccharides wherein the wt. % is based on the total weight of the composition.

16. The natural sweetener composition of claim 11 wherein the sugar alcohol comprises erythritol and the soluble fiber blend comprises isomalto-oligosaccharides and the composition has from about 0.1 wt. % to about 0.5 wt. % stevia extract, from about 0.5 wt. %. to about 1.2 wt. % monk fruit extract, from about 38 wt. % to about 60 wt. % erythritol, from about 0.05 wt. % to about 1.0 wt. % xanthan gum, and from about 15 wt. % to about 40 wt. % isomalto-oligosaccharides wherein the wt. % is based on the total weight of the composition.

17. The natural sweetener composition of claim 11 wherein the sugar alcohol comprises erythritol and the soluble fiber blend comprises isomalto-oligosaccharides and the composition has from about 0.05 wt. % to about 0.8 wt. % stevia extract, from about 0.3 wt. %. to about 2 wt. % monk fruit extract, from about 38 wt. % to about 50 wt. % erythritol, and from about 10 wt. % to about 50 wt. % isomalto-oligosaccharides wherein the wt. % is based on the total weight of the composition.

18. An ingestible product comprising the sweetener composition of claim 11.

19. A composition comprising from about 0.05 wt. % to about 0.75 wt. % stevia extract, from about 0.3 wt. %. to about 1.8 wt. % monk fruit extract, from about 40 wt. % to about 60 wt. % erythritol, from about 10 wt. % to about 50 wt. % isomalto-oligosaccharides, from about 10 wt. % to about 40 wt. % chicory root extract, and from about 8 wt. % to about 45 wt. % maize dextrin wherein the wt. % is based on the total weight of the composition.

20. A composition comprising from about 0.05 wt. % to about 0.5 wt. % stevia extract, from about 0.3 wt. %. to about 2 wt. % monk fruit extract, from about 38 wt. % to about 60 wt. % erythritol, from about 5 wt. % to about 10 wt. % isomalto-oligosaccharides, from about 10 wt. % to about 40 wt. % chicory root extract, and from about 8 wt. % to about 45 wt. % maize dextrin wherein the wt. % is based on the total weight of the composition.
